(19) United States
(12) Patent Application Publication
(10) Pub. No.: US 2022/0355377 A1
(43) Pub. Date: Nov. 10, 2022

(54) METHOD OF FORMING CONTIGUOUS CONDUCTIVE FEATURES ON A SUBSTRATE

(71) Applicant: XTPL S.A., Wroclaw (PL)

(72) Inventors: Mateusz LYSIEN, Zywiec woj. slaskie (PL); Aneta WIATROWSKA, Wroclaw (PL); Monika GADJA, Wroclaw (PL); Karolina FIACZYK, Wroclaw (PL); Filip GRANEK, Mrozów (PL)

(73) Assignee: XTPL S.A., Wroclaw (PL)

(21) Appl. No.: 17/621,540

(22) PCT Filed: Jul. 1, 2020
(86) PCT No.: PCT/IB2020/056215

§ 371 Date: Dec. 21, 2021

Related U.S. Application Data
(60) Provisional application No. 62/869,866, filed on Jul. 2, 2019.

(51) Int. Cl. B22F 7/04; B22F 1/107

(52) U.S. Cl. CPC B22F 7/04; B22F 1/107; B22F 2301/255; B22F 2302/25; B22F 2304/054

(57) ABSTRACT

A composition for forming a contiguous conductive feature on a substrate includes silver nanoparticles, a titanium precursor compound, a first non-aqueous polar protic solvent, and a second non-aqueous polar protic solvent. The concentration of the titanium precursor compound in the composition is in a range of 2 vol % to 13 vol %. A method of forming a contiguous conductive feature on a substrate includes dispensing the composition on the substrate to form a contiguous precursor feature and sintering the contiguous precursor feature at a sintering temperature in a range of 300° C. to 500° C. to form the contiguous conductive feature. Example titanium precursor compounds are: titanium(IV) butoxide, titanium(IV) isopropoxide, titanium(IV) chloride, tetrakis(diethylamido)titanium(IV), and dimethyltitanocene.

### BACKGROUND

Recent progress in nanoparticle ink compositions and ink printing apparatuses have enabled dispensing conductive nanoparticle features having line widths in a range of about 2 μm to 20 μm. Among various metallic nanoparticles, silver nanoparticles (AgNPs) have increasingly attracted interest for use in the electronics industries. Typically, polyvinylpyrrolidone (PVP) is used as a dispersant in making colloidal silver nanoparticles. It is possible to obtain silver nanoparticles with an average particle size in a range of 20 nm to 80 nm. The use of PVP as a dispersant affects the electrical conductivity of silver nanoparticles because the PVP present on the silver nanoparticle surfaces must be removed to obtain the best electrical conductivity. In order to effectively remove the PVP from the silver nanoparticle surfaces, a sintering process at a temperature of 300° C. or greater is desired (high-temperature sintering). However, it has been found that when a dispensed feature containing silver nanoparticles is subject to a high-temperature sintering treatment, the conductive feature may degrade. Degradation of the conductive feature manifests itself as any of the following: formation of numerous aggregated particles, loss of contiguity, and loss of adhesion to the substrate. When there is degradation of the conductive feature, the resulting electrical conductivity is low.

Therefore, there is a need for improved conductive nanoparticle compositions that can withstand high-temperature sintering. There is also a need for a method of forming a contiguous conductive feature, including dispensing an improved conductive nanoparticle composition to form a contiguous precursor feature and then subjecting the contiguous precursor feature to a high-temperature sintering step to form a contiguous conductive feature.

### SUMMARY

In one aspect, a composition for forming a contiguous conductive feature includes silver nanoparticles, a titanium precursor compound, a first non-aqueous polar protic solvent, and a second non-aqueous polar protic solvent. A concentration of the titanium precursor compound in the composition is in a range of 2 vol % to 13 vol %. Example titanium precursor compounds are: titanium alkoxide (including titanium(IV) butoxide and titanium(IV) isopropoxide), titanium(IV) chloride (including titanium(IV) chloride tetrahydrofuran complex), tetrakis(diethylamido)titanium(IV), and dimethyltitanocene. An example first non-aqueous polar protic solvent is propylene glycol and an example second non-aqueous polar protic solvent is glycerol.

In another aspect, a print head contains the composition described above.

In yet another aspect, a method of forming a contiguous conductive feature on a substrate includes dispensing the composition on a substrate to form a contiguous precursor feature and sintering the precursor feature at a temperature in a range of 300° C. to 500° C. for a time period of 5 minutes to 90 minutes to form a contiguous conductive feature. Preferably, the number density aggregated particles of 0.5 μm in diameter or greater does not exceed 60 aggregated particles per 200 μm² of the contiguous conductive feature.

In yet another aspect, the method of forming a contiguous conductive feature on a substrate additionally includes pre-processing the contiguous precursor feature at a temperature in a range of 100° C. to 300° C. for a time period of 5 minutes to 60 minutes.

The above summary of the present disclosure is not intended to describe each disclosed embodiment or every implementation of the present disclosure. The description that follows more particularly exemplifies illustrative embodiments. In several places throughout the application, guidance is provided through examples, which examples can be used in various combinations. In each instance of a list, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings, in which:

FIG. 1 is a flow diagram of a process of forming a conductive feature on a substrate.

FIG. 2 is a block diagram view of an illustrative fluid printing apparatus.

FIG. 3 is a schematic side view of a capillary glass tube.

FIG. 4 is a scanning electron microscope (SEM) view of a portion of a capillary glass tube.

FIG. 5 is a scanning electron microscope (SEM) view of a tapering portion of the capillary glass tube, under low magnification.

FIG. 6 is a scanning electron microscope (SEM) view of a tapering portion of the capillary glass tube, under high magnification.

FIG. 7 is a scanning electron microscope (SEM) view of the output portion after focused-ion beam treatment, under high magnification.

FIG. 8 is a flow diagram of a method of forming a micro-structural fluid ejector.

FIG. 9 is a flow diagram of a printing (dispensing) method.

FIG. 10 is a cut-away schematic side view of a print head.

FIG. 11 is an optical microscope image of conductive feature formed using a base silver nanoparticle composition and sintered at 300° C. for 5 min.

FIG. 12 is an optical microscope image of a conductive feature formed using a base silver nanoparticle composition and sintered at 300° C. for 45 min.

FIG. 13 is an optical microscope image of a conductive feature formed using a base silver nanoparticle composition and sintered at 300° C. for 90 min.

FIG. 14 is an optical microscope image of a conductive feature formed using a base silver nanoparticle composition and sintered at 350° C. for 5 min.

FIG. 15 is an optical microscope image of a conductive feature formed using a base silver nanoparticle composition and sintered at 350° C. for 45 min.

FIG. 16 is an optical microscope image of a conductive feature formed using a base silver nanoparticle composition and sintered at 350° C. for 90 min.

FIG. 17 is an optical microscope image of a conductive feature formed using an improved silver nanoparticle composition (TBT 5.1 vol %) and sintered at 300° C. for 5 min.

FIG. 18 is an optical microscope image of a conductive feature formed using an improved silver nanoparticle composition (TBT 5.1 vol %) and sintered at 300° C. for 45 min.

FIG. 19 is an optical microscope image of a conductive feature formed using an improved silver nanoparticle composition (TBT 5.1 vol %) and sintered at 300° C. for 90 min.

FIG. 20 is an optical microscope image of a conductive feature formed using an improved silver nanoparticle composition (TBT 5.1 vol %) and sintered at 350° C. for 5 min.

FIG. 21 is an optical microscope image of a conductive feature formed using an improved silver nanoparticle composition (TBT 5.1 vol %) and sintered at 350° C. for 45 min.

FIG. 22 is an optical microscope image of a conductive feature formed using an improved silver nanoparticle composition (TBT 5.1 vol %) and sintered at 350° C. for 90 min.

FIG. 23 is a scanning electron microscope (SEM) image of a conductive feature formed using a base silver nanoparticle composition and sintered at 350° C. for 45 min.

FIG. 24 is a scanning electron microscope (SEM) image of a conductive feature formed using an improved silver nanoparticle composition (TBT 5.1 vol %) and sintered at 300° C. for 5 min.

FIG. 25 is a scanning electron microscope (SEM) image of a conductive feature formed using an improved silver nanoparticle composition (TBT 5.1 vol %) and sintered at 350° C. for 90 min.

FIG. 26 is a scanning electron microscope (SEM) image of a conductive feature formed using an improved silver nanoparticle composition (TBT 2.0 vol %) and sintered at 350° C. for 90 min.

FIG. 27 is an optical microscope image of a conductive feature formed using an improved silver nanoparticle composition (TBT 8.3 vol %) and sintered at 350° C. for 90 min, before the adhesion test.

FIG. 28 is an optical microscope image of a conductive feature formed using an improved silver nanoparticle composition (TBT 8.3 vol %) and sintered at 350° C. for 90 min, after the adhesion test.

FIG. 29 is an optical microscope image of a conductive feature formed using an improved silver nanoparticle composition (TBT 2.0 vol %) and sintered at 350° C. for 90 min, after the adhesion test.

FIG. 30 is an optical microscope image of a conductive feature formed using an improved silver nanoparticle composition (TBT 0.5 vol %) and sintered at 350° C. for 90 min, after the adhesion test.

### DETAILED DESCRIPTION OF ILLUSTRATIVE EMBODIMENTS

The present disclosure relates to nanoparticle compositions and a method of forming a contiguous conductive feature on a substrate using such compositions.

In this disclosure:

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the present disclosure.

The terms “comprises” and variations thereof do not have a limiting meaning where these terms appear in the description and claims.

Unless otherwise specified, “a,” “an,” “the,” and “at least one” are used interchangeably and mean one or more than one.

The recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

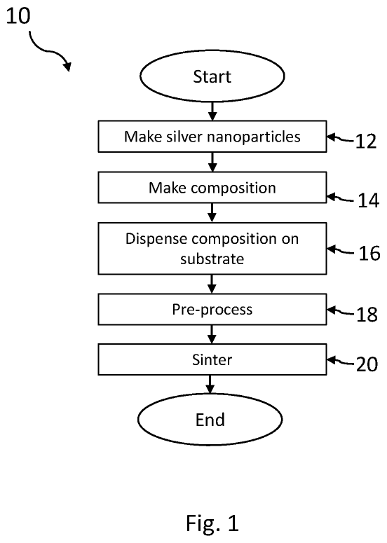

FIG. 1 is a flow diagram of a method 10 of forming a conductive feature on a printable surface of a substrate. In the present disclosure, metallic nanoparticles are used to form the conductive features. Among various metallic nanoparticles, silver nanoparticles (AgNPs) have increasingly attracted interest for use in the electronics industries. Accordingly, the present disclosure is directed toward improving compositions containing silver nanoparticles. At step 12, the silver nanoparticles are made. The synthesis of silver nanoparticles is described in detail in Example 1 hereinbelow. Generally, the synthesis of silver nanoparticles in solution employs three components: (1) metal precursors (e.g., AgNO₃); (2) reducing agents (e.g., ethylene glycol); and (3) stabilizing (capping) agents (e.g., polyvinylpyrrolidone). Polyvinylpyrrolidone, abbreviated as PVP, is soluble in water and other polar solvents. When PVP is effectively used as a dispersant, stable colloidal silver nanoparticles covered (capped) with PVP polymer can be obtained in very small size (<100 nm) because the PVP reduces the aggregation of the silver nanoparticles.

The average size of the silver nanoparticles can be controlled to within a range of 35 nm to 65 nm, or more broadly within a range of 20 nm to 80 nm. The average particle size and dispersity can be controlled by controlling thermodynamic and kinetic reaction parameters. Reaction temperature, temperature ramp, and reaction time are the important thermodynamic reaction parameters. The rate of adding reagents and molar ratio of used silver precursor to stabilizing agent (PVP) are the important kinetic reaction parameters. An appropriate combination of these parameters leads to obtaining nanoparticles that exhibit the desired properties of small particles size, low dispersity, and high dispersion stability (low occurrence of aggregation).

At step 14, a composition is made from the silver nanoparticles from step 12. The preparation of examples of compositions is described in detail in Comparative Example and Example 2 hereinbelow. Generally, the silver nanoparticles are separated, to remove impurities and excess PVP, and dispersed in a first solvent. Subsequently, a second solvent is added to the composition. The composition may optionally include additives to better control its physicochemical properties. These additives include surfactants, binders, adhesion promoters, and antifoaming agents. We have found that the concentration of such additives should not exceed 1% by weight in the composition.

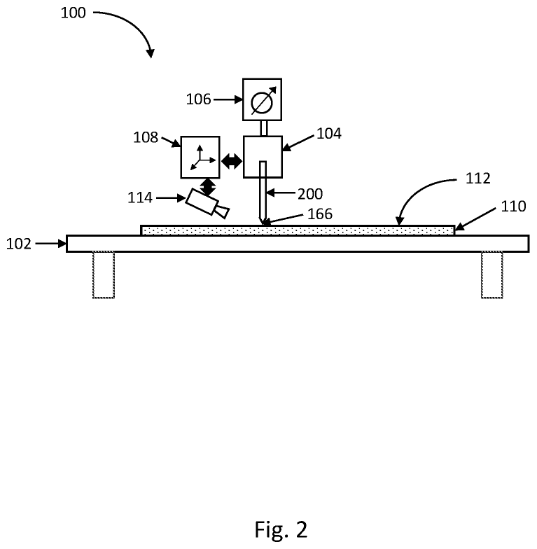

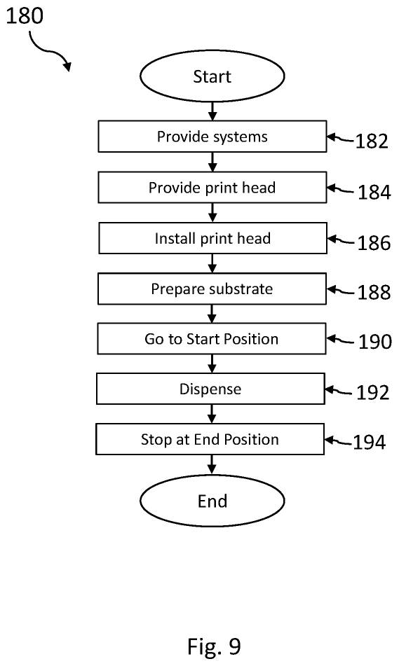

At step 16, the composition is dispensed (printed) on a printable surface of a substrate using a fluid printing apparatus. Step 16 corresponds to method 180 shown in FIG. 9. In the experimental results described herein, the composition is dispensed on a clean glass substrate to form a precursor feature. In experiments that we have conducted, the precursor feature is typically in the form of a line having a length of approximately 2 cm. The line widths are typically in a range of 5 μm to 15 μm. It is possible to obtain line widths in a range of 2 μm to 20 μm. Details of an illustrative fluid printing apparatus and methods of printing are described in detail with reference to FIGS. 2 through 10. Nevertheless, the nanoparticle compositions described herein are not limited to being used in these illustrative fluid printing apparatuses.

At step 18, the work piece, i.e., the substrate with the precursor feature thereon, undergoes optional pre-processing. For example, the work piece can be pre-processed in a convection oven at a temperature in a range of 100° C. to 200° C. for a period of 5 minutes to 60 minutes. During the pre-processing step, solvents remaining in the precursor feature are vaporized. It has been found that the pre-processing step can improve the adhesion of the dispensed feature to the substrate.

At step 20, the work piece is sintered. A purpose of the sintering is to convert the precursor feature to a conductive feature having satisfactory electrical conductivity properties. For example, the work piece can be sintered in a convection oven at a temperature in a range 300° C. to 500° C. for a period of 5 minutes to 90 minutes. The use of PVP as a capping agent reduces the aggregation of silver nanoparticles in the silver nanoparticle compositions, but the capping of the nanoparticle surfaces by PVP results in lower electrical conductivity. The sintering process removes the PVP and organic remains. Therefore, sintering is important for bringing out high electrical conductivity in the resulting conductive features.

TABLE 1

| | | | Boiling | | No. of | Surface | |
|---|---|---|---|---|---|---|---|
| | Molecular | Density | point | | hydroxyl | tension | Use in |
| Solvent | weight | (g/ml) | (° C.) | Viscosity (cP) | groups | (mN/m) | Composition |
| Propylene glycol | 76.09 | 1.036 | 187.4 | 48.6 (25° C.) | 2 | 45.6 | First Solvent |
| Ethylene glycol | 62.07 | 1.113 | 197 | 16.9 (25° C.) | 2 | 48.4 | First Solvent |
| Diethylene glycol | 106.12 | 1.118 | 245 | 35.7 (25° C.) | 2 | 44.8 | First Solvent |
| Glycerol | 92.09 | 1.261 | 290 | 1408 (20° C.), | 3 | 63.4 | Second Solvent |
| | | | | 610 (30° C.) | | | |

Since PVP is soluble in water and other polar solvents, polar solvents are used to make silver nanoparticle compositions. Some suitable solvents and their physicochemical properties are summarized in Table 1, ordered by boiling point. The listed solvents are all polar solvents, with 2 or 3 hydroxyl groups in the molecular structure. The boiling point ranges from 187.4° C. (propylene glycol) to 290° C. (glycerol), and the viscosity ranges from 16.9 cP (ethylene glycol) to ^{˜}10³ cP (glycerol).

The suspension stability of a silver nanoparticle composition is measured by placing a sample of the composition in a cuvette and measuring the ultraviolet-visible (UV-vis) absorption spectra as a function of time. A suspension stability rating of “excellent” means that the composition is stable for more than 1 month. It has been found that compositions with better stability tend to exhibit less nanoparticle agglomeration in the nozzle of the print head. The Comparative Example gives details of preparing a silver nanoparticle composition containing propylene glycol as the first solvent and glycerol as the second solvent. The Comparative Example composition exhibits excellent suspension stability. Ethylene glycol and diethylene glycol can also be used as a first solvent in a silver nanoparticle composition.

The Comparative Example describes a silver nanoparticle composition that contains a first solvent of propylene glycol (boiling point 187.4° C., viscosity 48.6 cP, 2 hydroxyl groups) and a second solvent of glycerol (boiling point 290° C., viscosity ⁻10³ cP, 3 hydroxyl groups), in which a concentration of glycerol in the conductive ink composition is about 17.8% by volume. The concentration of silver nanoparticle in the ink is about 42.3 wt %. The Comparative Example Ink was measured to have excellent suspension stability. It is thought that the excellent suspension stability of the Comparative Example Ink is related to the relatively high boiling points and relatively large viscosities of the two solvents. The extremely large viscosity of glycerol is attributable to the presence of three hydroxyl groups; therefore, glycerol is hygroscopic. However, no water was intentionally added to the ink composition. It is preferable to limit the use of water, methanol, ethanol, 1-propanol, and 2-propanol in the silver nanoparticle composition. It is preferable to limit the concentration of water, methanol, ethanol, 1-propanol, and 2-propanol, in aggregate, to 10.0% or less of the silver nanoparticle composition by volume.

The Comparative Example composition can be dispensed on a substrate (step 16 of FIG. 1) using a suitable fluid printing apparatus. Illustrative fluid printing apparatuses and methods of printing are described with reference to FIGS. 2 through 10.

An illustrative fluid printing apparatus is explained with reference to FIG. 2. FIG. 2 is a block diagram view of an illustrative fluid printing apparatus. The fluid printing apparatus 100 includes a substrate stage 102, a print head 104, a pneumatic system 106, and a print head positioning system 108. A substrate 110 is fixed in position on the substrate stage 102 during the printing (dispensing) and has a printable surface 112, which is facing upward and facing towards the print head 104. The print head 104 is positioned above the substrate 110. The print head includes a nozzle 200, and the nozzle 200 includes an output portion 166.

The substrate 110 can be of any suitable material, such as glass or silicon. A flexible substrate can also be used. Furthermore, the substrate can have existing metal lines, circuitry, or other deposited materials thereon. For example, the present disclosure relates to an open defect repair apparatus, which can print lines in an area where there is an open defect in the existing circuit. In such case, the substrate can be a thin-film transistor array substrate for a liquid crystal display (LCD).

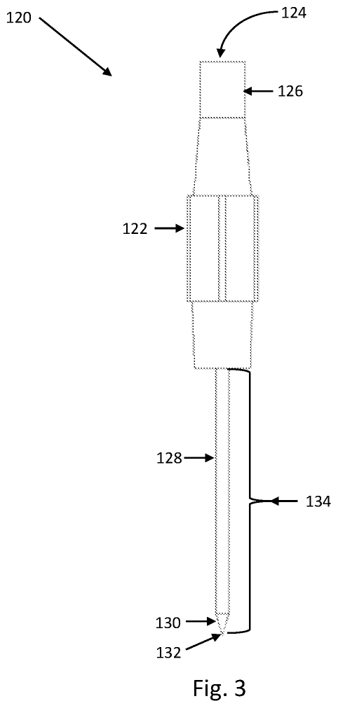

The print head includes a nozzle. Commercially available capillary glass tubes can be modified to a micro-structural fluid ejector, which can be used as a nozzle. For example, capillary glass tubes called Eppendorf™ Femtotips™ Microinjection Capillary Tips, with an inner diameter at the tip of 0.5 μm, are available from Fisher Scientific. A commercially available capillary glass tube 120 is shown schematically in FIG. 3. A plastic handle 122 is attached to the capillary glass tube 120 around its circumference. The plastic handle 122 includes an input end 124 and a threaded portion 126 near the input end 124 which enables a threaded connection to an external body or external conduit (not shown in FIG. 3). The input end 124 has an inner diameter of 1.2 mm.

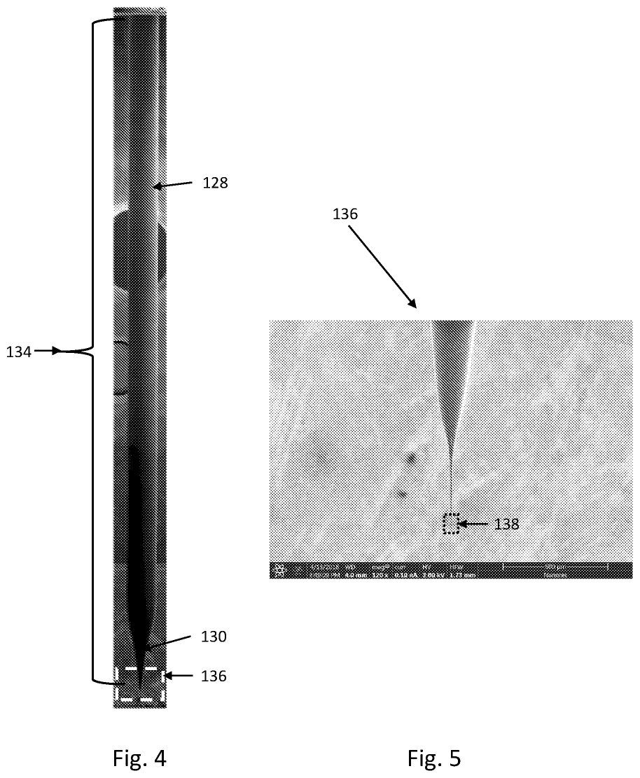

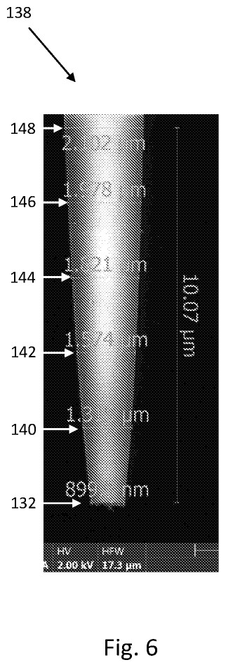

The capillary glass tube includes an elongate input portion 128 and a tapering portion 130. There is an externally visible portion 134 of the capillary glass tube 120. Some of the elongate input portion 128 may be obscured by the surrounding plastic handle 122. The tapering portion 130 tapers to an output end 132 with a nominal inner diameter of 0.5 μm. The reduction of diameter along the tapering portion 130 from the elongate input portion 128 to the output end 132 is more clearly illustrated in FIGS. 4 through 6. FIG. 4 is a scanning electron micrograph view (formed from stitching together multiple SEM images) of the entire externally visible portion 134 of the capillary glass tube 120. A first magnification region 136 of the tapering portion 130 including the output end 132, observed under low magnification in a scanning electron microscope (SEM), is shown in FIG. 5. Furthermore, a second magnification region 138 located within the first magnification region 136, observed under high magnification in a scanning electron microscope (SEM), is shown in FIG. 6. The outer diameter measured at the output end 132 and at different longitudinal locations along the tapering portion (140, 142, 144, 146, and 148) are shown in FIG. 6 and in Table 2. The outer diameter is smallest at the output end 132 and increases with increasing longitudinal distance from the output end 132. A longitudinal distance 90 between output end 136 and longitudinal location 148 is measured to be approximately 10.07 μm.

TABLE 2

| Longitudinal Location | Outer diameter (μm) |
|---|---|
| 148 | 2.102 |
| 146 | 1.978 |
| 144 | 1.821 |
| 142 | 1.574 |
| 140 | 1.315 |
| 132 | 0.8993 |

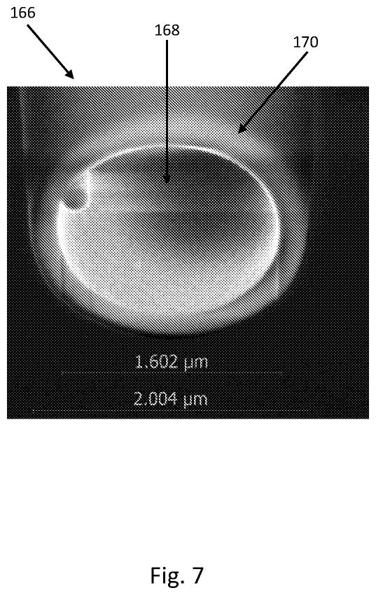

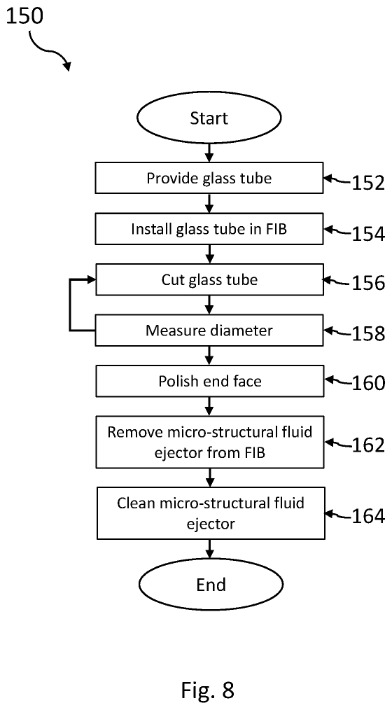

In a case where the output inner diameter (nominally 0.5 μm in this example) is too small, it is possible to increase the output inner diameter by cutting the capillary glass tube 120 at a suitable longitudinal location along the tapering portion 130, for example longitudinal location 140, 142, 144, 146, or 148. A method 150 of treating the capillary glass tube 120 to obtain a micro-structural fluid ejector 200 is shown in FIG. 8. At step 152, a capillary glass tube 120, such as shown in FIG. 3 is provided. At step 154, the capillary glass tube is installed in a focused-ion beam (FIB) apparatus. For example, a plasma-source Xe⁺ FIB (also called PFIB) is used. At step 156, a longitudinal location along the tapering portion 130 is selected, and the focused ion beam is directed to it, with sufficient energy density for cutting the glass tube. At step 156, a cut is made using the focused-ion beam across the tapering portion at the selected longitudinal location. After the previous step 156 is completed, a scanning electron microscope (in the FIB apparatus) is used to measure the inner diameter at the output end (step 158). If the measured inner diameter is too small, step 156 is carried out at another longitudinal location along the tapering portion, and step 158 is carried out. Steps 156 and 158 are repeated until the desired inner diameter is obtained. As shown in FIG. 7, the final cutting (step 156) defines an output portion 166 including the exit orifice 168 and the end face 170. In many cases, the exit orifice 168 has an output inner diameter ranging between 0.1 μm and 5 μm. However, the output inner diameter can be chosen to be greater than 5 μm. In the example shown in FIG. 7, the output inner diameter is measured to be 1.602 μm and the output outer diameter is measured to be 2.004 μm. The output inner diameter and input inner diameter should be chosen such that the input inner diameter is greater than the output inner diameter by a factor of at least 100. In this case, the input inner diameter (inner diameter of the input end 124) is 1.2 mm, which is greater than the output inner diameter of 1.602 μm by a factor of approximately 749. If an output inner diameter of 5 μm is used, the same input inner diameter would be greater than the output inner diameter by a factor of approximately 240.

Then, at step 160, the energy of the focused ion beam is reduced, and the focused ion beam is directed to the end face 170. The end face 170 is polished using the focused ion beam, to obtain an end face with a surface roughness of less than 0.1 μm, and preferably ranging between 1 nm and 20 nm. In the end face example shown in FIG. 7, it can be deduced from the outer and inner diameter dimensions that the end face has a surface roughness of less than 0.1 μm. When the polishing capability of the FIB apparatus is taken into account, it is considered likely that the surface roughness of the end face ranges between 1 nm and 20 nm. Upon the conclusion of step 160, a micro-structural fluid ejector is obtained. Then, at step 162, the micro-structural fluid ejector is removed from the FIB apparatus. Additionally, it is preferable to clean the micro-structural fluid ejector, particularly the output portion, by immersion in a solvent while applying pressure in the range of 0.1 bar (10,000 Pa) to 10 bar (1,000,000 Pa) (step 164). We have found it effective to use a solvent that is identical to a solvent used in the fluid. For example, if the fluid contains propylene glycol, it is found effective to use propylene glycol as a solvent for cleaning in this step 164. The foregoing is a description of an example of a micro-structural fluid ejector obtained by modification of a capillary glass tube. More generally, it is contemplated that a nozzle can be obtained from other materials, such as plastics, metals, and silicon, or from a combination of materials.

Upon completion of step 162 and/or step 164, the micro-structural fluid ejector is ready to use. FIG. 9 is a flow diagram of a dispensing method 180, in which a fluid printing apparatus is operated (FIG. 2). Method 180 corresponds to step 16 of FIG. 1. At step 182, systems in the fluid printing apparatus 100, including a substrate stage 102, a pneumatic system 106, a print head positioning system 108, and an imaging system 114, are provided. At step 184, a print head 104 is provided. This step includes preparing a nozzle 200 and installing it in a print head 104. The micro-structural fluid ejector, the making of which is described in FIG. 8, can be used as the nozzle 200. The output inner diameter of the nozzle affects the line width of the dispensed feature. Typically, the line width is greater than the output inner diameter of the nozzle by a factor of 1 to 10. At step 186, the print head 104 is installed in the fluid printing apparatus 100. This step 186 includes positioning the print head 104 above the substrate 110 with the exit orifice 168 pointing downward and facing toward the substrate 110. Step 186 additionally includes providing a supply of the nanoparticle composition made at step 14 (FIG. 1). Typically, the nanoparticle composition is transferred to the nozzle 200 through the input portion. Step 186 additionally includes coupling a pneumatic system 106 to the print head 104. Typically, the pneumatic system includes a pump and a pressure regulator. The pneumatic system is capable of applying pressure in a range of 0 to 6 bar to the input portion of the nozzle. After the nanoparticle composition has been transferred to the nozzle and the pneumatic system has been coupled to the print head, and before dispensing of the ink onto the substrate begins, a high pressure is applied to the input portion, typically in a range of 1.5 bar to 2.0 bar. Under the higher pressure, the nanoparticle composition is dispensed continuously from the nozzle, reducing the probability of clogging of the nanoparticle composition in the nozzle. If pressure is applied to the fluid in the nozzle when the nozzle is not in contact with the substrate, ejected fluid travels upward along the outer wall of the tapering portion. Depending on the physico-chemical properties of the fluid and the surface properties of the outer wall, droplets may form on the outer wall.

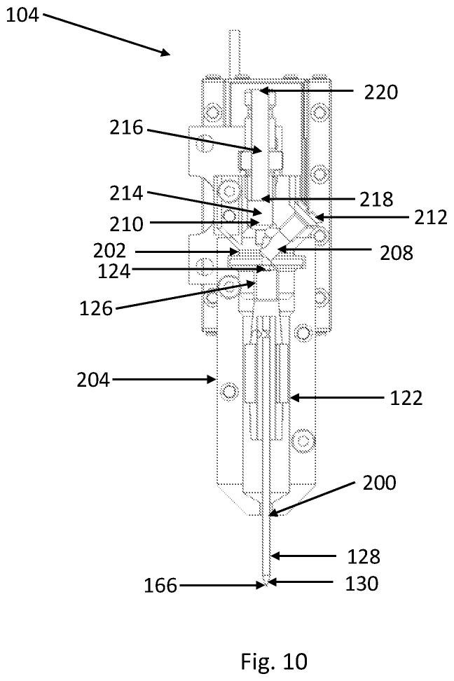

An example of a print head 104 is shown in FIG. 10. The print head 104 includes a nozzle 200. A portion of the nozzle 200, and its plastic handle 122, are encased in the external housing 204. The elongate input portion 128 extends downward from the external housing 204. An output portion 166, including the exit orifice 168 and end face 170 (FIG. 7), are located downward from the elongate input portion 128. The tapering portion 130 is located between the output portion 166 and the elongate input portion 128. The external housing 204 encases a main body 202, which includes a pneumatic conduit 210 and a fluid conduit 208. Both the pneumatic conduit 210 and the fluid conduit 208 are connected to the input end 124 of the plastic handle 122. The plastic handle 122 is attached to the main body 202 by the threaded portion 126 of the plastic handle 122. The pneumatic conduit 210 has a threaded portion 214 on its input end which is used to attach the output end 218 of a pneumatic connector 216 thereto. The pneumatic connector 216 has an input end 220 to which the pneumatic system 106 is connected (not shown in FIG. 10). Fluid (for example, a nanoparticle composition) is supplied to the nozzle 200 via the fluid conduit 208. As shown in FIG. 10, fluid conduit 208 is plugged with a fluid inlet plug 212, after fluid has been supplied to the micro-structural fluid ejector 200. The nanoparticle composition can be stored in the nozzle 200 in the print head 104, or the nanoparticle composition can be stored in a fluid reservoir that supplies ink to the print head 104 via the fluid conduit 208.

The dispensing method 180 is explained with continuing reference to FIGS. 2 and 9. The print head positioning system 108 controls the vertical displacement of the print head 104 and the lateral displacement of the print head 104 relative to the substrate. At step 190, the print head is moved to the start position. At step 190, the print head positioning system 108 is operated to laterally displace the print head 104 relative to the substrate 110. The lateral displacement of the print head relative to the substrate means one of the following options: (1) the substrate is stationary and the print head is moved laterally; (2) the print head is not moved laterally and the substrate is moved laterally; and (3) both the print head and the substrate are moved laterally. In option (1), the print head is moved laterally and vertically. In option (2), the print head is moved vertically but is not moved laterally, and the substrate stage, to which the substrate is fixed in position, is moved laterally. Additionally, in option (2), the print head positioning system 108 comprises a vertical positioner coupled to the print head 104 and a lateral positioner coupled to the substrate stage. Additionally, at step 190, the print head positioning system 108 is operated to control a vertical distance between the output portion 166 of the nozzle and the printable surface 112 to within a range of 0 μm to 5 μm. Typically, the nozzle is lowered toward the substrate such that the vertical distance between the output portion 166 and the printable surface 112 of the substrate 110 is within a range of 0 μm to 5 μm.

At step 192, the nanoparticle composition is dispensed onto the substrate 110 from the nozzle 200, while the print head 104 is laterally displaced relative to the substrate 110 from the start position to the end position along a trajectory. During this step 192, pressure applied to the input portion by the pneumatic system is typically in a range of 0.1 bar to 1.5 bar, which is a lower pressure than the high pressure applied before dispensing begins. It is hypothesized that a meniscus protrudes from the exit orifice 168 and contacts the printable surface 112, and there is wetting tension by virtue of contact between the fluid and the printable surface 112. At step 194, lateral displacement of the print head 104 relative to the substrate 110 is complete at the end position. Typically, the nozzle 200 is raised away from the substrate 110 such that the vertical distance between the output portion 166 and the printable surface 112 of the substrate 110 is greater than 10 μm, and a high pressure in a range of 1.5 bar to 2.0 bar is applied to the input portion.

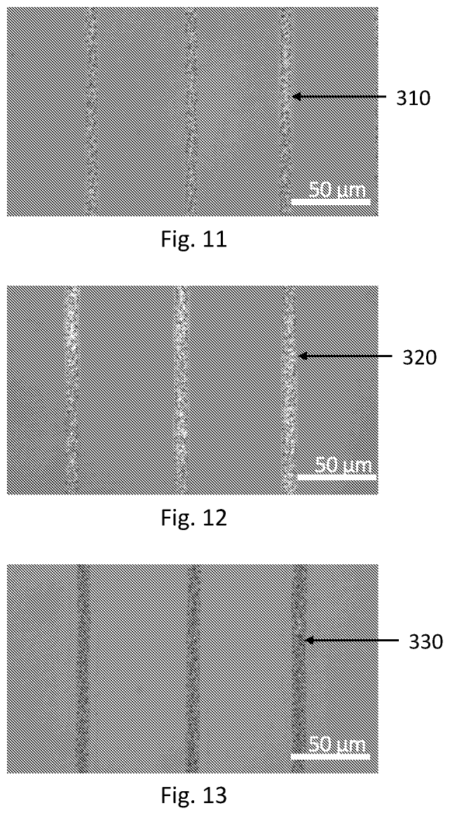

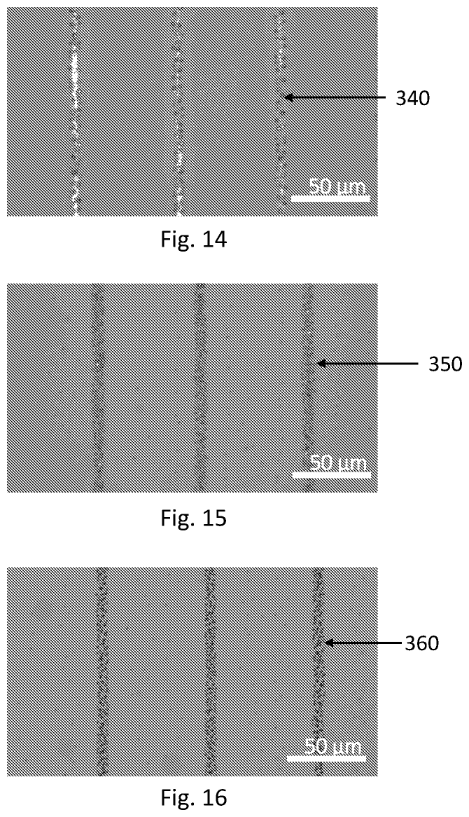

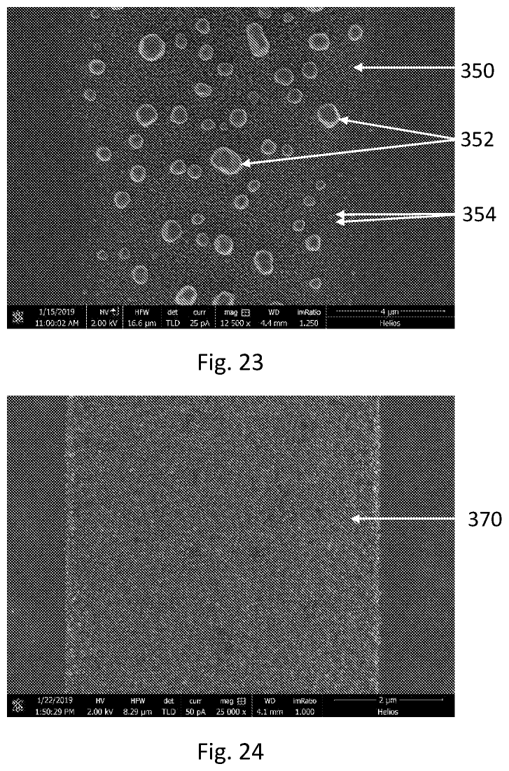

The Comparative Example composition (silver nanoparticle composition, a first solvent of propylene glycol, a second solvent of glycerol) was installed in the fluid printing apparatus and dispensed on a clean glass substrate to form lines each having a line width in a range of 5 μm to 15 μm and a length of approximately 2 cm. Multiple samples were formed and sintered under different conditions. The samples were sintered at a temperature of 300° C. or 350° C. for a sintering time of 5 min, 45 min, or 90 min. Optical microscope images of features (lines) dispensed using the Comparative Example composition after sintering are shown in FIGS. 11 through 16. The respective figure number, dispensed feature identifier, dispensed composition, sintering temperature, and sintering time are listed in Table 3 herein. A scanning electron microscope (SEM) image of a dispensed nanoparticle feature (line) (Comparative Example composition), sintered at a sintering temperature of 350° C. for a sintering time of 45 min, is shown in FIG. 23. FIG. 23 shows the result of the same sintering conditions as FIG. 15.

After sintering, the features 310, 320, 330, 340, 350, and 360, dispensed using the Comparative Example composition were rated as poor. FIG. 23 is a scanning electron micrograph that shows the sintered feature 350 (Comparative Example composition, sintering temperature of 350° C., sintering time of 5 minutes) in greater detail. The sintered feature 350 consists of individual grains 354 that are no longer contiguous. Therefore, the electrical conductivity of the sintered feature 350 would be quite low. A sintered feature is rated as “poor” when the feature is not contiguous. Additionally, feature 350 is characterized by the presence of numerous aggregated particles. At least some of the particle aggregates are 0.5 μm in diameter or greater (352). The Comparative Example composition that was used to form feature 350 contained nanoparticles having an average particle diameter in a range of 35 nm to 65 nm. The nanoparticles has aggregated into larger particles during the sintering.

TABLE 3

| | | | Sintering | Sintering | |
|---|---|---|---|---|---|
| FIG. | Feature | Dispensed | Temperature | Time | Rating of |
| No. | No. | Composition | [° C.] | [min] | Feature |
| 11 | 310 | Comparative | 300 | 5 | Poor |
| | | Example | | | |
| 12 | 320 | Comparative | 300 | 45 | Poor |
| | | Example | | | |
| 13 | 330 | Comparative | 300 | 90 | Poor |
| | | Example | | | |
| 14 | 340 | Comparative | 350 | 5 | Poor |
| | | Example | | | |
| 15, 23 | 350 | Comparative | 350 | 45 | Poor |
| | | Example | | | |
| 16 | 360 | Comparative | 350 | 90 | Poor |
| | | Example | | | |
| 17, 24 | 370 | Example 2 | 300 | 5 | Excellent |
| 18 | 380 | Example 2 | 300 | 45 | Excellent |
| 19 | 390 | Example 2 | 300 | 90 | Excellent |
| 20 | 400 | Example 2 | 350 | 5 | Excellent |
| 21 | 410 | Example 2 | 350 | 45 | Excellent |
| 22, 25 | 420 | Example 2 | 350 | 90 | Excellent |

An improved silver nanoparticle composition was prepared by addition of a titanium precursor compound, titanium(IV) butoxide (abbreviated TBT), to the Comparative Example composition. The preparation of this improved nanoparticle composition containing silver nanoparticles and TBT is explained in Example 2. In the case of Example 2, the concentration of TBT in the composition is approximately 5.1 vol % (3.6 wt %). Compositions containing other titanium precursor compounds and/or different concentrations of titanium precursor compounds are possible and discussed herein.

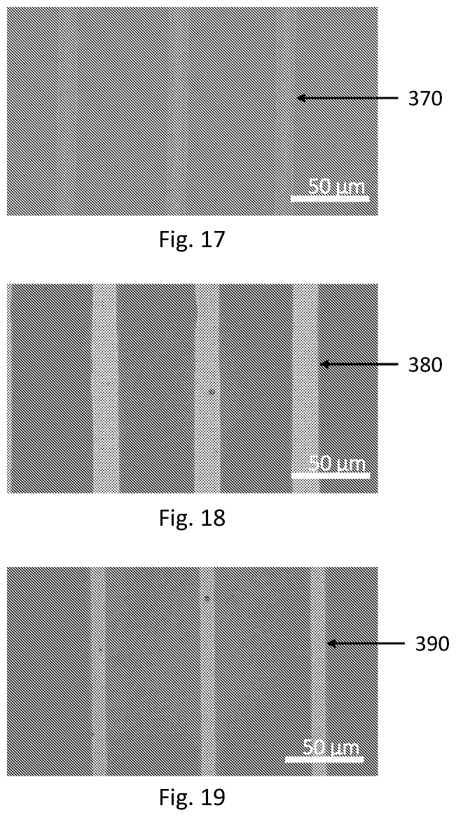

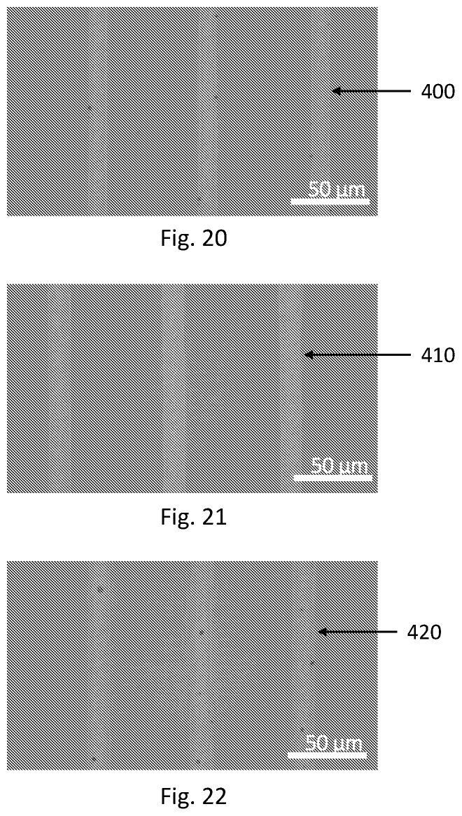

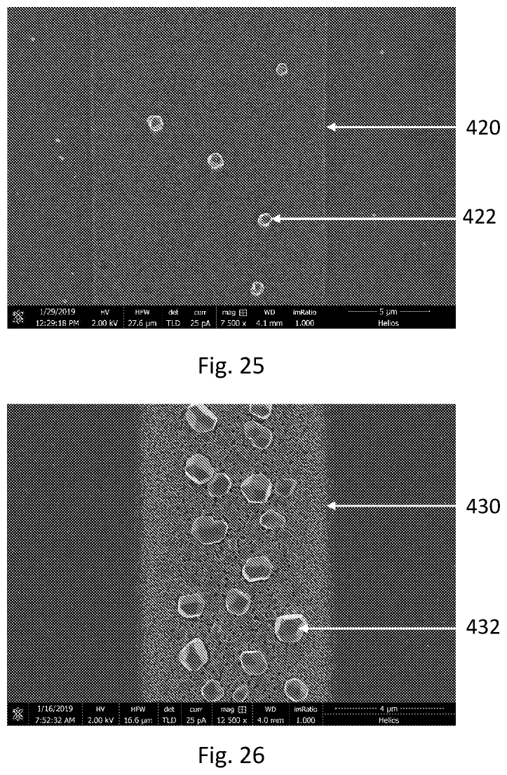

The Example 2 composition was installed in the fluid printing apparatus and dispensed on a clean glass substrate to form lines each having a line width in a range of 5 μm to 15 μm and a length of approximately 2 cm. Multiple samples were formed and sintered under different conditions. The samples were sintered at a temperature of 300° C. or 350° C. for a sintering time of 5 min, 45 min, or 90 min. Optical microscope images of features (lines) dispensed using the Example 2 composition after sintering are shown in FIGS. 17 through 22. The respective figure number, dispensed feature identifier, dispensed ink, sintering temperature, and sintering time are listed in Table 3 herein. A scanning electron microscope (SEM) image of a dispensed nanoparticle feature (line) (Example 2 composition), sintered at a sintering temperature of 300° C. for a sintering time of 5 min, is shown in FIG. 24. FIG. 24 shows the result of the same sintering conditions as FIG. 17. In addition, a scanning electron microscope (SEM) image of a dispensed nanoparticle feature (line) (Example 2 composition), sintered at a sintering temperature of 350° C. for a sintering time of 90 min, is shown in FIG. 25. FIG. 25 shows the result of the same sintering conditions as FIG. 22.

After sintering, the features 370, 380, 390, 400, 410, and 420, dispensed using the Example 2 composition exhibited excellent quality. FIG. 24 is a scanning electron micrograph that shows the sintered feature 370 (Example 2 composition, sintering temperature of 300° C., sintering time of 5 min) in greater detail. The sintered feature 370 is contiguous and therefore its electrical conductivity would be quite high. Additionally, aggregated particles 0.5 μm in diameter or greater are not visible in FIG. 24. FIG. 25 is a scanning electron micrograph that shows the sintered feature 420 (Example 2 composition, sintering temperature of 350° C., sintering time of 90 min) in greater detail. The sintered feature 420 is contiguous and therefore its electrical conductivity would be quite high. However, aggregated particles 0.5 μm in diameter or greater (422) are visible in FIG. 25. In the case of FIG. 25, the conductive feature (line) 420 has a line width of approximately 14.5 μm, and the length of the visible portion of the line is approximately 18.4 μm. Hence the visible area is approximately 266.8 μm². There are 5 aggregated particles measuring 0.5 μm in diameter or greater (422) in the visible area of FIG. 25. The number density of aggregated particles measuring 0.5 μm in diameter or greater is approximately 1.9 aggregated particles per 100 μm². A sintered feature is rated as “excellent” when the feature is contiguous and the number density of aggregated particles measuring 0.5 μm in diameter or greater (if any) does not exceed 5 aggregated particles per 200 μm² of the feature.

Titanium(IV) butoxide (TBT) is known to undergo hydrolysis to form titanium dioxide and butanol. The Comparative Example composition contains propylene glycol and glycerol, which are hygroscopic. One can hypothesize that silver-TiO₂ core-shell nanoparticles would be formed during the mixing of TBT into the silver nanoparticle ink composition (Comparative Example composition) to form the Example 2 composition, dispensing of the Example 2 composition onto a substrate, and sintering. For example, one can hypothesize that silver nanoparticles have better stability in a high-temperature environment when encapsulated inside TiO₂ shells. However, TiO₂ is a transition metal oxide semiconductor, so it may lower electrical conductivity if present at a sufficiently high concentration in a silver nanoparticle composition.

Improved silver nanoparticle compositions were prepared at TBT concentrations of 0.5 vol % (0.4 wt %), 2.0 vol % (1.5 wt %), 4.0 vol % (2.9 wt %), and 8.3 vol % (6.0 wt %). These compositions were prepared according to procedures identical to that described in Example 2, except that the amounts of added TBT were adjusted accordingly. Each composition was dispensed onto a clean glass substrate, and sintered at a sintering temperature of 350° C. for a sintering time of 90 min. The processing conditions and results are summarized in Table 4 herein. A composition containing TBT at 0.5 vol % resulted in a feature rated as “poor” after sintering. A composition containing TBT at 2.0 vol % resulted in a feature rated as “good” after sintering. FIG. 26 is a scanning electron micrograph that shows the sintered feature 430 (composition containing TBT at 2.0 vol %, sintering temperature of 350° C., sintering time of 90 min) in greater detail. The sintered feature 430 is contiguous. However, aggregated particles 0.5 μm in diameter or greater (432) are visible in FIG. 26. In the case of FIG. 26, the conductive feature (line) 430 has a line width of approximately 6.83 μm. The number density of aggregated particles measuring 0.5 μm in diameter or greater is approximately 23 aggregated particles per 100 μm² of the feature. A sintered feature is rated as “good” when the feature is contiguous and the number density of aggregated particles measuring 0.5 μm in diameter or greater (if any) does not exceed 60 aggregated particles per 200 μm² of the feature. Compositions containing 4.0 vol % and 8.3 vol % of TBT resulted in conductive lines that were rated as “excellent”. However, there was clogging in the nozzle when dispensing the silver nanoparticle composition containing 8.3 vol % of TBT.

TABLE 4

Sintering

| TBT | Temperature | Time | Rating of |
|---|---|---|---|
| vol % | [° C.] | [min] | Feature |
| 0.5 | 350 | 90 | Poor |
| 2.0 | 350 | 90 | Good |
| 4.0 | 350 | 90 | Excellent |
| 8.3 | 350 | 90 | Excellent* |

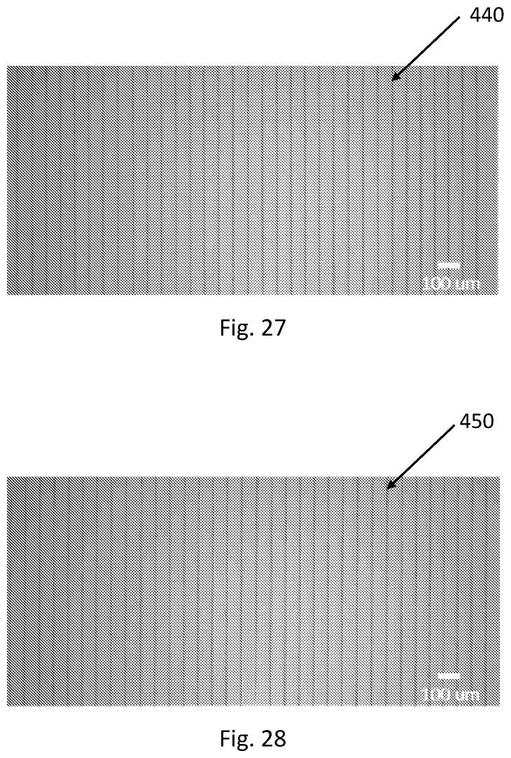

It was found that the adhesion of the feature to the substrate is dependent on the concentration of TBT in the composition. FIG. 27 is an optical microscope image of sintered features (lines) 440 dispensed using an improved silver nanoparticle composition containing 8.3 vol % of TBT and sintered at a sintering temperature of 350° C. for a sintering time of 90 min. As explained with reference to Table 4, these sintered features 440 are rated as excellent. An adhesion test using adhesive tape was performed on the sample. A patch of adhesive tape was affixed to the substrate on the side having the features 440 thereon and then rapidly removed. FIG. 28 is an optical microscope image of the sintered sample of FIG. 27, after the adhesion test. The sintered features after adhesion test 450 (FIG. 28) do not differ noticeably from the sintered features before adhesion test 440 (FIG. 27). Therefore, the improved silver nanoparticle composition containing 8.3 vol % of TBT exhibits satisfactory adhesion.

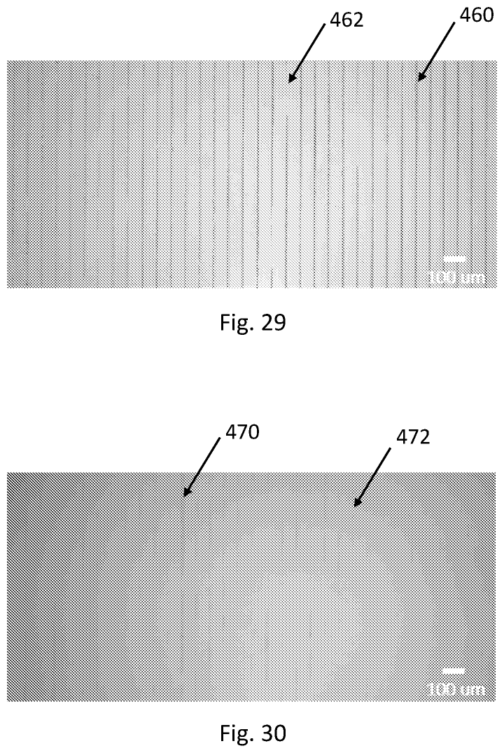

Similarly, adhesion tests were performed on sintered features that were dispensed using improved silver nanoparticle compositions containing 0.5 vol % of TBT and 2.0 vol % of TBT and sintered at a sintering temperature of 350° C. for a sintering time of 90 min (Table 4). FIG. 29 is an optical microscope image of the sintered features 460 formed using an improved silver nanoparticle composition containing 2.0 vol % of TBT and sintered at a sintering temperature of 350° C. for a sintering time of 90 min, after the adhesion test. Most of the sintered features 460 are intact but there are some regions 462 where the sintered features have delaminated during the adhesion test. FIG. 30 is an optical microscope image of the sintered features 470 formed using an improved silver nanoparticle composition containing 0.5 vol % of TBT and sintered at a sintering temperature of 350° C. for a sintering time of 90 min, after the adhesion test. In most regions 472, the sintered features have delaminated during the adhesion test. Therefore, a TBT concentration of 0.5 vol % in the silver nanoparticle composition is likely insufficient for achieving adhesion of the features to the glass substrate.

As shown in FIG. 1, the method 10 of forming a conductive feature on a substrate includes an optional pre-processing step 18 that precedes the sintering step (step 20). During the pre-processing step 18, solvents remaining in the precursor feature are vaporized. Improved silver nanoparticle compositions were prepared at TBT concentrations of 4.0 vol % and 8.3 vol %. These compositions were prepared according to procedures identical to that described in Example 2, except that the amounts of added TBT were adjusted accordingly. Each composition was dispensed onto a clean glass substrate, pre-processed under varying conditions, and then sintered at a sintering temperature of 350° C. for a sintering time of 90 min. The processing conditions and results are summarized in Table 5 herein. In the case of a TBT concentration of 4.0 vol %, 4 different pre-processing conditions were used: (1) no pre-processing; (2) 100° C., 60 min; (3) 200° C., 60 min; and (4) 500° C., 5 min. In the case of a TBT concentration of 8.3 vol %, 3 different pre-processing conditions were used: (1) no pre-processing; (2) 100° C., 60 min; and (3) 200° C., 60 min.

At a TBT concentration of 4.0 vol %, a conductive feature subject to no pre-processing and sintering at 350° C. for 90 min was rated as excellent. When the pre-processing conditions were changed to 100° C., 60 min and 200° C., 60 min, the rating did not change from excellent. The conductive features that were pre-processed at 100° C., 60 min and 200° C., 60 min exhibited better adhesion to the substrate than the lines that were not subject to pre-processing. The features that were pre-processed at 500° C., 5 min were rated as good, compared to excellent for features that were not subject to pre-processing. Pre-processing at a pre-processing temperature of 500° C., even for a pre-processing time as short as 5 min, caused the rating of the feature to decline from excellent to good. It is preferable to select a pre-processing temperature in a range of 100° C. to 300° C., and it is more preferable to select a pre-processing temperature in a range of 100° C. to 200° C.

TABLE 5

| | Pre-processing | | Sintering | | |
|---|---|---|---|---|---|
| TBT | Temperature | Time | Temperature | Time | Rating of |
| vol % | [° C.] | [min] | [° C.] | [min] | Feature |
| 4.0 | None | — | 350 | 90 | Excellent |
| 4.0 | 100 | 60 | 350 | 90 | Excellent |
| 4.0 | 200 | 60 | 350 | 90 | Excellent |
| 4.0 | 500 | 5 | 350 | 90 | Good |
| 8.3 | None | — | 350 | 90 | Excellent* |
| 8.3 | 100 | 60 | 350 | 90 | Excellent* |
| 8.3 | 200 | 60 | 350 | 90 | Excellent* |

At a TBT concentration of 8.3 vol %, a conductive line subject to no pre-processing and sintering at 350° C. for 90 min exhibited excellent line quality. However, clogging was observed to occur in the nozzles. When the pre-processing conditions were changed to 100° C., 60 min and 200° C., 60 min, the line quality stayed at excellent. The lines that were pro-processed at 100° C., 60 min and 200° C., 60 min exhibited better adhesion to the substrate than the lines that were not subject to pre-processing.

Improved silver nanoparticle compositions were prepared at TBT concentrations of 4.0 vol % (2.9 wt %) and 13.0 vol % (9.4 wt %). These compositions were prepared according to procedures identical to that described in Example 2, except that the amounts of added TBT were adjusted accordingly. Each composition was dispensed onto a clean glass substrate and processed under varying conditions. The processing conditions and results are summarized in Table 6 herein. In the case of a TBT concentration of 4.0 vol %, 4 different processing conditions were used: (1) no pre-processing, sintering at 350° C. for 5 min; (2) pre-processing at 500° C. for 5 min, sintering at 350° C. for 5 min; (3) no pre-processing, sintering at 400° C. for 5 min; (3) no pre-processing, sintering at 500° C. for 5 min. In the case of a TBT concentration of 13.0 vol %, 2 different processing conditions were used: (1) no pre-processing, sintering at 350° C. for 5 min; and (2) no pre-processing, sintering at 500° C. for 5 min.

TABLE 6

| | Pre-processing | | Sintering | | |
|---|---|---|---|---|---|
| TBT | Temperature | Time | Temperature | Time | Rating of |
| vol % | [° C.] | [min] | [° C.] | [min] | Feature |
| 4.0 | None | — | 350 | 5 | Excellent |
| 4.0 | 500 | 5 | 350 | 5 | Good |
| 4.0 | None | — | 400 | 5 | Good |
| 4.0 | None | — | 500 | 5 | Good |
| 13.0 | None | — | 350 | 5 | Poor |
| 13.0 | None | — | 500 | 5 | Good |

At a TBT concentration of 4.0 vol %, a conductive feature subject to no pre-processing and sintering at 350° C. for 5 min was rated as excellent. When a pre-processing step of 500° C. for 5 min was added, with the sintering conditions staying the same (350° C. for 5 min), the rating of the feature declined from excellent to good. This is another indication that it is preferable to select a pre-processing temperature in a range of 100° C. to 300° C. When the sintering temperatures were increased to 400° C. and 500° C., with the sintering time being held constant at 5 min, the rating of the feature declined from excellent to good. On the other hand, at a TBT concentration of 13.0 vol %, a conductive feature subject to no pre-processing and sintering at 350° C. for 5 min was rated as poor. When the sintering temperature was increased to 500° C., with the sintering time being held constant at 5 min, the rating of the feature improved from poor to good.

Titanium(IV) butoxide is a type of titanium alkoxide. Titanium(IV) isopropoxide, which is another titanium alkoxide, can also be used in silver nanoparticle compositions. Titanium(IV) isopropoxide is abbreviated as TTIP. Improved silver nanoparticle compositions were prepared at TTIP concentrations of 4.5 vol % (2.4 wt %), 8.6 vol % (4.8 wt %), and 12.3 vol % (7.2 wt %). These compositions were prepared according to procedures identical to that described in Example 2, except that TTIP was used instead of TBT, and the amounts of added TTIP were adjusted accordingly. Each composition was dispensed onto a clean glass substrate and sintered at 350° C. for 90 min. These samples were not subjected to pre-processing. The processing conditions and results are summarized in Table 7 herein. At a TTIP concentration of 4.5 vol %, a conductive feature sintered at 350° C. for 90 min was rated as excellent. At TTIP concentrations of 8.6 vol % and 12.3 vol %, conductive features sintered at 350° C. for 90 min were rated as good.

TABLE 7

Sintering

| TTIP | Temperature | Time | Rating of |
|---|---|---|---|
| vol % | [° C.] | [min] | Feature |
| 4.5 | 350 | 90 | Excellent |
| 8.6 | 350 | 90 | Good |
| 12.3 | 350 | 90 | Good |

Improved silver nanoparticle compositions were prepared at TTIP concentrations 4.5 vol %, 8.6 vol %, and 12.3 vol %. These compositions were prepared according to procedures identical to that described in Example 2, except that TTIP was used instead of TBT, and the amounts of added TTIP were adjusted accordingly. Each composition was dispensed onto a clean glass substrate and sintered at 500° C. for 5 min. The processing conditions and results are summarized in Table 8 herein. At TTIP concentration of 4.5 vol %, 8.6 vol %, and 12.3 vol %, conductive features sintered at 500° C. for 5 min were rated as good. At a TTIP concentration of 8.6 vol %, conductive lines sintered at 500° C. for 5 min exhibited good line quality.

TABLE 8

Sintering

| TTIP | Temperature | Time | Rating of |
|---|---|---|---|
| vol % | [° C.] | [min] | Feature |
| 4.5 | 500 | 5 | Good |
| 8.6 | 500 | 5 | Good |
| 12.3 | 500 | 5 | Good |

Other titanium precursor compounds can be used in improved silver nanoparticle compositions. Possible titanium precursor compounds include: titanium(IV) butoxide, titanium(IV) isopropoxide, titanium(IV) chloride, tetrakis(diethylamido)titanium(IV), and dimethyltitanocene. Titanium(IV) chloride may be in the form of titanium(IV) chloride tetrahydrofuran complex. The abbreviations, formulas, and molecular weights of these compounds are shown in Table 9 herein. Improved silver nanoparticle compositions have been prepared using these titanium precursors. Such improved silver nanoparticle compositions have been used to dispense conductive features that withstood the high temperatures of a sintering step.

TABLE 9

| | | | Molecular |
|---|---|---|---|
| Titanium precursor | Abbreviation | Formula | weight |
| Titanium(IV) butoxide | TBT | Ti(OCH₂CH₂CH₂CH₃)₄ | 340.32 |
| Titanium(IV) isopropoxide | TTIP | Ti[OCH(CH₃)₂]₄ | 284.22 |
| Titanium(IV) chloride | TTC | TiCl₄ | 189.68 |
| Titanium(IV) chloride | TTC-THF | TiCl₄ + 2[C₄H₈O] | 333.89 |
| tetrahydrofuran complex | | | |
| Tetrakis(diethylamido)titanium(IV) | TDEAT | Ti[(C₂H₅)₂N]₄ | 336.38 |
| Dimethyltitanocene | | Ti C₁₂H₁₆ | 208.13 |

In order to impart sufficient high temperature stability for a sintering step and sufficient adhesion to the substrate, the concentration of titanium precursor compound in the improved silver nanoparticle composition is preferably 2 vol % or more, and more preferably 4 vol % or more. On the other hand, the concentration of titanium precursor compound in the improved silver nanoparticle composition is preferably not greater than 13 vol %, and more preferably not greater than 9 vol %, in order to reduce the occurrence of clogging in the nozzle and to avoid a decrease in electrical conductivity.

The Comparative Example composition contained silver nanoparticles at a concentration of approximately 42.3 wt %. The Example 2 composition contained silver nanoparticles at a concentration of approximately 33 wt %. The concentration of silver nanoparticles in an improved silver nanoparticle composition is preferably in a range of 8 wt % to 70 wt % and more preferably in a range of 15 wt % to 60 wt %.

The Comparative Example composition and the Example 2 composition contained propylene glycol as a first non-aqueous polar protic solvent (sometimes referred to as “first solvent”) and glycerol as a second non-aqueous polar protic solvent (sometimes referred to as “second solvent”). An improved silver nanoparticle composition contains a first non-aqueous polar protic solvent and a second non-aqueous polar protic solvent. Preferably, the first solvent has a boiling point of at least 110° C. and a viscosity of at least 10 cP at 25° C. Preferably, the first solvent has two hydroxyl groups. Preferably, the first solvent is ethylene glycol or diethylene glycol. More preferably, the first solvent is propylene glycol. Preferably, the second solvent has a boiling point of at least 200° C. and a viscosity of at least 100 cP at 25° C. Preferably, the second solvent has three hydroxyl groups. More preferably, the second solvent is glycerol.

The Example 2 composition contained glycerol (the second non-aqueous polar protic solvent) at a concentration of approximately 16.9 vol %. The concentration of the second non-aqueous polar protic solvent in an improved silver nanoparticle composition is preferably 11 vol % or greater.

According to a method of forming a contiguous conductive feature on a substrate, the improved silver nanoparticle composition is dispensed on a substrate to form a contiguous precursor feature. In all of the experiments described herein, glass substrates were used. In order to attain sufficient electrical conductivity, the line width of the contiguous precursor feature is preferably 2 μm or more, and more preferably 5 μm or more. On the other hand, when a conductive feature has line widths of 20 μm or more, there is greater probability of aggregated particle formation during sintering. The line width of the contiguous precursor feature is preferably 20 μm or less, and more preferably 15 μm or less. In the experiments described herein, the precursor features were typically about 150 nm in thickness (after vaporization of the solvents). In order to attain sufficient electrical conductivity, the thickness of the precursor feature is preferably 100 nm or more. On the other hand, precursor features of greater than 1000 nm in thickness would be difficult to dispense uniformly. The thickness of the precursor feature is preferably 1000 nm or less.

According to a method of forming a contiguous conductive feature on a substrate, the contiguous precursor feature is sintered at a sintering temperature for a time period of 5 minutes to 90 minutes to form a contiguous conductive feature. The sintering temperature is preferably in a range of 300° C. to 500° C. and more preferably in a range of 300° C. to 400° C. Optionally, the contiguous precursor feature undergoes a pre-processing step, in which the contiguous precursor feature is pre-processed at a pre-processing temperature for a time period of 5 min to 60 min. The pre-processing step is carried out before the sintering step, and after the contiguous precursor feature has been formed on the substrate. The pre-processing temperature is preferably in a range of 100° C. to 300° C. and more preferably in a range of 100° C. to 200° C.

### EXAMPLES

### Example 1

### Nanoparticle

Stage A. Reagents Preparation

Synthesis of PVP-capped silver nanoparticles (AgNP's) with average diameter of 50 nm was performed by using the polyol, precursor hot injection method.

50.1 g of polyvinylpyrrolidone (PVP) powder (viscosity grade K-30) was transferred into 250 ml three-neck reaction flask with magnetic stirring bar, and then 125 ml of ethylene glycol was added. Reaction flask was placed in heating mantle and heated to 100° C. under vigorous stirring with glass rod to initially dissolve PVP powder. At 100° C. reflux condenser was set, and solution was heated to 120° C., and kept in this temperature under magnetic stirring at 400 RPM (revolutions per minute). Orange color of solution was observed.

Concurrently, 6.25 g of AgNO₃ was placed into 50 ml beaker with 25.0 ml of ethylene glycol and covered with tinfoil. Solution was magnetically stirred at 600 RPM to complete dissolution of silver salt for about 20 min (silver precursor solution).

Stage B. Synthesis

Silver precursor solution (at room temperature) in ethylene glycol was rapidly poured (below 5 sec) into reaction flask with hot PVP solution at 120° C. under stirring. Reaction mixture was heated for 60 min and cooled to room temperature (RT) in cool water bath. After addition of AgNO₃ solution, color change was observed from orange to dark red and then to dark green at final stage. After cooling, obtained dispersion was kept stirred. Small sample was collected for UV-VIS absorption spectra measurement.

### Comparative Example

Stage C. Separation and Purification of Silver Nanoparticles

The obtained dispersion (namely, the dispersion obtained in Example 1) was equally divided into four 500 ml Nalgene PPCO centrifuge bottles. The procedure of washing the residuals from the reaction flask was then carried out. To the reaction flask from which the liquid was poured out, 50 ml of ethylene glycol was added and shaken. Subsequently, this liquid was poured equally into the same four Nalgene PPCO centrifuge bottles, in which there was a dispersion of nanoparticles.

Then, mixture containing 180 ml of acetone and 20 ml of ethylene glycol was added to each bottle and shaken up well to form rusty—brown precipitate suspensions. If precipitation did not proceed well, color of solution was still dark green. In that case, small volumes (single milliliters) of acetone were added drop by drop to obtain proper precipitate color. Suspensions were centrifuged at 2000×g (RCF) for 15 min. The shiny, reflective silver cakes at bottom of the bottles were obtained. The clear, orange supernatants were discarded. In next step, 30 ml of ethanol was added to each bottle in order to remove an excess of PVP and impurities after reaction. Silver nanoparticles were stirred and re-dispersed in ultrasonic bath for 10 min, at 35° C. Silver nanoparticles were then centrifuged at 10,000×g for 35 minutes. Resultant, orange clear supernatant was discarded, and silver cake was re-dispersed in 30 ml of ethanol in ultrasonic bath for 10 minutes at 35° C.

Two batches of nanoparticles dispersions were mixed together and transferred to 100 ml round—bottom flask containing 6.0 ml of propylene glycol, and gently shaken. Suspension was placed in rotary evaporator (120 RPM), at water bath temperature of 43° C., and lowered pressure of 40 mbar (4000 Pa) for 35 minutes. The resultant highly concentrated silver nanoparticles dispersion in propylene glycol was placed in ultrasonic bath for 5 minutes and filtered through 1.0 μm nylon syringe filter to a clean PP container (Nalgene). Suspension was stored in refrigerator at 4° C. Small volume (0.110 ml) was collected for silver mass concentration measurements. The average silver nanoparticles mass concentration in the concentrate samples was equal to about 42.3 wt %. The average silver nanoparticles mass concentration in the concentrate samples was defined as [weight of silver nanoparticles]/[volume of concentrate].

Stage D. Addition of Second Solvent

Highly concentrated silver nanoparticles dispersion of about 42.3 wt % in propylene glycol was mixed with anhydrous glycerol (second solvent) by volume ratio 3.7:0.8, shaken well, and placed in ultrasonic bath for 5 minutes. The concentration of glycerol in the resulting composition is about 17.8% by volume. Silver nanoparticles composition was filtered through 1.0 μm nylon syringe filter and stored in PP container at 4° C. Concentration of AgNP's in obtained ink is about 34.8 wt %. Directly before using, the composition was placed in ultrasonic bath for 2 minutes. Optionally, it can be filtered by using 1.0 μm PA Nylon syringe filter.

### Example 2

Stage C. Separation and Purification of Silver Nanoparticles

This Stage C is identical to Stage C in Comparative Example.

Stage D. Addition of Second Solvent

This Stage D is identical to Stage D in Comparative Example.

Stage E. Addition of Titanium Precursor

0.54 ml of a titanium precursor compound, titanium(IV) butoxide (abbreviated TBT) was added to 10 ml of the Comparative Example silver nanoparticles composition obtained at Stage D. The resulting composition was homogenized by vigorous shaking in an ultrasonic bath for 5 min, and then filtered through a 1.0μm PA Nylon syringe filter into a clean PP container (Nalgene). The concentration of TBT in the composition was approximately 5.1 vol % (3.6 wt %). The concentration of silver nanoparticles in the resulting composition was 33 wt %. The concentration of glycerol in the resulting composition was 16.9 vol %.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the present disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A method of forming a contiguous conductive feature on a substrate, comprising the steps of:
dispensing a composition comprising silver nanoparticles, a titanium precursor compound, a first non-aqueous polar protic solvent, and a second polar protic solvent, on the substrate to form a contiguous precursor feature; and
sintering the contiguous precursor feature at a sintering temperature for a time period of 5 minutes to 90 minutes to form a contiguous conductive feature;
wherein a concentration of the titanium precursor compound in the composition is in a range of 2 vol % to 13 vol %; and
wherein the sintering temperature is in a range of 300° C. to 500° C.

2. The method of claim 1, wherein the sintering temperature is in a range of 300° C. to 400° C.

3. The method of claim 1, wherein the contiguous precursor feature has a line width in a range of 2 μm to 20 μm.

4. The method of claim 3, wherein the contiguous precursor feature has a line width in a range of 5 μm to 15 μm.

5. The method of claim 1, wherein the contiguous precursor feature has a thickness in a range of 100 nm to 1000 nm.

6. The method of claim 1, wherein the contiguous conductive feature additionally comprises aggregated particles of 0.5 μm in diameter or greater, a number density of the aggregated particles not exceeding 60 aggregated particles per 200 μm² of the contiguous conductive feature.

7. The method of claim 6, wherein the number density of aggregated particles of 0.5 μm in diameter or greater does not exceed 5 aggregated particles per 200 μm² of the contiguous conductive feature.

8. The method of claim 1, wherein the titanium precursor compound is titanium alkoxide.

9. The method of claim 8, wherein the titanium alkoxide is selected from the following: titanium(IV) butoxide and titanium(IV) isopropoxide.

10. The method of claim 1, wherein the titanium precursor compound is selected from the following: titanium(IV) chloride, tetrakis(diethylamido)titanium(IV), and dimethyltitanocene, wherein titanium(IV) chloride can be present as titanium(IV) chloride tetrahydrofuran complex.

11. The method of claim 1, wherein the concentration of the titanium precursor compound in the composition is in a range of 4 vol% to 9 vol%.

12. The method of claim 1, wherein a concentration of the silver nanoparticles in the composition is in a range of 8 wt% to 70 wt%.

13. The method of claim 12, wherein the concentration of the silver nanoparticles in the composition is in a range of 15 wt% to 60 wt%.

14. The method of claim 1, wherein the silver nanoparticles have an average particle size in a range of 20 nm to 80 nm.

15. The method of claim 14, wherein the silver nanoparticles have an average particle size in a range of 35 nm to 65 nm.

16. The method of claim 1, wherein the composition additionally comprises polyvinylpyrrolidone present on the silver nanoparticle surfaces.

17. The method of claim 1, wherein the first non-aqueous polar protic solvent has a first boiling point of at least 110° C. and a first viscosity of at least 10 cP at 25° C.

18. The method of claim 1, wherein the first non-aqueous polar protic solvent has two hydroxyl groups.

19. The method of claim 1, wherein the first non-aqueous polar protic solvent is propylene glycol.

20. The method of claim 1, wherein the first non-aqueous polar protic solvent is selected from the following: ethylene glycol and diethylene glycol.

21. The method of claim 1, wherein the second non-aqueous polar protic solvent has a second boiling point of at least 200° C. and a second viscosity of at least 100 cP at 25° C.

22. The method of claim 1, wherein the second non-aqueous polar protic solvent has three hydroxyl groups.

23. The method of claim 1, wherein the second non-aqueous polar protic solvent is glycerol.

24. The method of claim 1, wherein a concentration of the second non-aqueous polar protic solvent in the composition is 11.0% by volume or greater.

25. The method of claim 1, additionally comprising a step of:
pre-processing the contiguous precursor feature at a pre-processing temperature for a time period of 5 minutes to 60 minutes;
wherein said step of pre-processing the contiguous precursor feature is carried out before the step of sintering the contiguous precursor feature; and
wherein the pre-processing temperature is in a range of 100° C. to 300° C.

26. The method of claim 25, wherein the pre-processing temperature is in a range of 100° C. to 200° C.

27. The method of claim 1, wherein the contiguous conductive feature is adherent to the substrate.

28. The method of claim 1, wherein the substrate is a glass substrate.

29. A composition for forming a contiguous conductive feature on a substrate, comprising:
silver nanoparticles;
a titanium precursor compound;
a first non-aqueous polar protic solvent; and
a second non-aqueous polar protic solvent;
wherein a concentration of the titanium precursor compound in the composition is in a range of 2 vol% to 13 vol%.

30. The composition of claim 29, wherein the concentration of the titanium precursor compound in the composition is in a range of 4 vol% to 9 vol%.

31. The composition of claim 29, wherein the titanium precursor compound is titanium alkoxide.

32. The composition of claim 31, wherein the titanium alkoxide is selected from the following: titanium(IV) butoxide and titanium(IV) isopropoxide.

33. The composition of claim 29, wherein the titanium precursor compound is selected from the following: titanium(IV) chloride, tetrakis(diethylamido)titanium(IV), and dimethyltitanocene, wherein titanium(IV) chloride can be present as titanium(IV) chloride tetrahydrofuran complex.

34. The composition of claim 29, containing a concentration of the silver nanoparticles in the composition is in a range of 8 wt% to 70 wt%.

35. The composition of claim 34, wherein the concentration of the silver nanoparticles in the composition is in a range of 15 wt% to 60 wt%.

36. The composition of claim 29, wherein the silver nanoparticles have an average particle size in a range of 20 nm to 80 nm.

37. The composition of claim 36, wherein the silver nanoparticles have an average particle size in a range of 35 nm to 65 nm.

38. The composition of claim 29, additionally comprising polyvinylpyrrolidone present on the silver nanoparticle surfaces.

39. The composition of claim 29, wherein the first non-aqueous polar protic solvent has a first boiling point of at least 110° C. and a first viscosity of at least 10 cP at 25° C.

40. The composition of claim 29, wherein the first non-aqueous polar protic solvent has two hydroxyl groups.

41. The composition of claim 29, wherein the first non-aqueous polar protic solvent is propylene glycol.

42. The composition of claim 29, wherein the first non-aqueous polar protic solvent is selected from: ethylene glycol and diethylene glycol.

43. The composition of claim 29, wherein the second non-aqueous polar protic solvent has a second boiling point of at least 200° C. and a second viscosity of at least 100 cP at 25° C.

44. The composition of claim 29, wherein the second non-aqueous polar protic solvent has three hydroxyl groups.

45. The composition of claim 29, wherein the second non-aqueous polar protic solvent is glycerol.

46. The composition of claim 29, wherein a concentration of the second non-aqueous polar protic solvent in the conductive ink precursor composition is 11.0% by volume or greater.

47. A print head comprising the composition of claim 29.
